(19) United States
(12) Patent Application Publication
(10) Pub. No.: US 2026/0206890 A1
(43) Pub. Date: Jul. 23, 2026

(54) CONVERTIBLE FABRIC-BASED UTILITY DEVICE

(71) Applicant: Whitney Trujillo, CARMEL, IN (US)

(72) Inventor: Whitney Trujillo, CARMEL, IN (US)

(21) Appl. No.: 19/033,852

(22) Filed: Jan. 22, 2025

(51) Int. Cl. A41D 19/01; A41D 19/015; B32B 5/02; B32B 5/26

(52) U.S. Cl. CPC A41D 19/01; A41D 19/01576; B32B 5/022; B32B 5/265; B32B 2250/40; B32B 2307/306; B32B 2307/728; B32B 2571/00

(57) ABSTRACT

A multi-functional fabric towel configured for gripping, drying, or shielding heated or wet objects. The towel is formed of a continuous absorbent fabric body having opposed surfaces and a finished peripheral edge. A pocket section is integrated along the outer back edge, the pocket defining an opening oriented rearwardly to receive a user's hand. Layered fabric contact within the pocket provides heat resistance and improved control while maintaining flexibility for general towel use. The article is suitable for use in kitchens, workshops, or outdoor environments without auxiliary attachments.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent documents or the patent disclosure, as it appears in the Patent and Trademark Office patent files or records, but otherwise reserves all copyrights and trade dress rights whatsoever.

### TECHNICAL FIELD

The present disclosure pertains to the technical field of fabric-based household textiles and utility towels. More specifically, it relates to a convertible multi-functional towel designed for versatile use in domestic and outdoor environments. The towel may function interchangeably as a drying towel, pot holder, trivet, or oven mitt, providing protection from heat, absorption of moisture, and flexibility in handling. This multifunctional construction eliminates the need for separate magnetic attachments, drawstrings, or insulated padding found in some prior art, offering a simplified all-fabric alternative suited for kitchens, workshops, and other settings requiring adaptable textile solutions.

### PRIOR ART

The field of fabric-based household textiles encompasses numerous designs intended to improve the convenience and functionality of towels, pot holders, oven mitts, and trivets. These articles are essential in both domestic and commercial settings, and extensive efforts have been made to enhance their versatility, safety, and ease of use.

Traditional towels have been designed primarily for drying and wiping applications, with materials selected for their absorbency and softness. Pot holders and oven mitts, on the other hand, have been tailored to provide thermal insulation, often incorporating materials like cotton, silicone, or other synthetic fibers known for their heat-resistant properties. Trivets have been designed to protect surfaces from heat damage, typically constructed from materials such as wood, silicone, or composite materials. Each of these products addresses a single function, and users commonly need several separate items to accomplish basic kitchen or household tasks.

Various patents have sought to combine these functions or improve their usability. For instance, U.S. Pat. No. 5,629,071 to Feldman discloses a convertible beach towel with handles and a pillow assembly for lounging use. U.S. Pat. No. 4,856,912 to Damus describes a towel convertible into a bag by means of drawstrings. U.S. Pat. No. 4,885,195 to Chang and U.S. Pat. No. 7,955,683 to Ferrell both introduce magnetic or ferromagnetic components to allow a towel to adhere to metal surfaces. U.S. Patent Publication No. 2016/0081519 to Manko provides a towel with silicone inserts to prevent slippage, while U.S. Pat. No. 4,731,276 to Manning and U.S. Patent Publication No. 2004/0131820 to Turner address specialized textile structures such as laminated or tufted webs to alter feel and durability.

While these designs represent notable advancements, most rely on added components such as drawstrings, magnets, loops, silicone pads, neoprene layers, or quilted batting to achieve multifunctionality or attachment. These added materials can reduce flexibility, limit washability, and complicate manufacturing, None of the cited references disclose or suggest a continuous, all-fabric towel featuring a rearwardly oriented hand pocket that enables the user to safely grasp heated or wet objects without additional materials or hardware.

The present disclosure therefore addresses the remaining need for a simplified, integrated textile solution that combines the absorbent qualities of a towel with the heat-handling functionality of a pot holder or oven mitt, while eliminating the non-fabric elements and conversion mechanisms found in prior designs. The inventive towel achieves this through a layered fabric construction and a hand pocket formed along the outer back edge with a rearward-facing opening, allowing the towel to serve interchangeably as a towel, trivet, or gripping aid.

Accordingly, although prior art references such as Damus, Feldman, Chang, Ferrell, Manko, Turner, and Manning have each contributed innovations in the area of multifunctional household textiles, none disclose the unique combination of simplicity, fabric continuity, and ergonomic pocket orientation achieved by the present towel. This construction represents an improvement that provides versatility and practicality without reliance on external attachments or specialized synthetic materials.

### BACKGROUND OF THE INVENTION

Fabric-based household textiles such as towels, pot holders, oven mitts, and trivets are widely used in kitchens, bathrooms, and outdoor environments. Each is typically designed to serve a distinct function. Towels are primarily used for drying or wiping, while pot holders and oven mitts are intended to protect the user's hand from heat when handling cookware. Trivets protect surfaces from damage by providing a thermal barrier between a hot object and a countertop or table.

These fabric articles are commonly produced from absorbent and durable materials such as cotton, linen, or microfiber. The selection of fabric depends on the intended application. For instance, cotton and linen are chosen for their absorbency and softness, while blended fabrics may be selected for enhanced durability. Prior art has introduced heat-resistant layers or synthetic coatings such as neoprene or silicone; however, these materials can add stiffness, reduce washability, and alter the tactile feel of the textile.

Variations in construction have also been developed to improve utility or convenience. Some designs incorporate pockets or loops for storage or hanging, and others include magnets or ferromagnetic inserts for attachment to metal surfaces. Quilted padding or batting has been used in certain heat-protective textiles to provide insulation. While these features offer specific benefits, they also increase manufacturing complexity and limit versatility. None of these prior solutions disclose or suggest a continuous all-fabric towel that integrates a rearwardly oriented hand pocket without additional hardware, insulation, or attachments.

Consequently, users often rely on multiple separate items. One for drying, another for gripping, and another for heat protection, all depending on the task. This multiplicity can be inefficient and inconvenient during routine household or culinary activities. The present towel addresses this limitation by combining the absorbent and protective qualities of these textiles into a single, adaptable article that maintains flexibility, washability, and simplicity of construction.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Additional details and variations will become apparent from the following description and accompanying drawings.

According to one aspect of the present disclosure, a multi-functional fabric towel is provided. The towel comprises a generally rectangular absorbent body having opposed front and back surfaces and a continuous finished peripheral edge. A pocket portion is integrally formed along the outer back edge of the towel body, the pocket defining an opening oriented rearwardly (outwardly) to receive the user's hand. The pocket allows the towel to be comfortably and securely grasped for handling heated, wet, or slippery objects, while also enabling the towel to lie flat for use as a drying surface or folded within itself to be used as a trivet. The towel may be fabricated from cotton, linen, microfiber, or other absorbent woven or nonwoven textile materials. The construction does not include magnets, ferromagnetic disks, metallic fasteners, drawstrings, loops, silicone, neoprene, quilting, or insulating batting.

The towel's pocket structure provides heat protection and grip through the composition and configuration of its fabric. In certain embodiments, the pocket is constructed as a discrete fabric panel attached along its perimeter to the towel body, forming an enclosed region that receives the user's hand. The pocket panel may be made from two layers of fabric joined along their edges to create a dual-ply region offering enhanced thermal resistance, or from a single layer of thick, heat-resistant fabric sufficient to perform the same function. In all cases, the pocket is oriented rearwardly along the outer back edge of the towel body. The absence of synthetic inserts and hardware maintains softness, flexibility, and washability. In use, the towel can be readily converted from a general drying cloth to a pot holder, oven mitt, or trivet simply by inserting or removing the user's hand from the rearward pocket.

### BRIEF DESCRIPTION OF DRAWINGS

Non-limiting and non-exhaustive examples are described with reference to the following figures.

FIG. 1 is a top view of the interior side of the towel body showing the pocket panel and rearward pocket opening.

FIG. 2 is a top view of the exterior side of the towel body showing the continuous finished seam and the stitching line securing the pocket to the towel body.

FIG. 3 is a top view showing the first folding step in which the right long edge of the towel body is folded inward toward the center line.

FIG. 4 is a top view showing the second folding step in which the left long edge of the towel body is folded inward toward the center line adjacent to the previously folded right-hand portion.

FIG. 5 is a top view showing the top edge of the towel being folded downward toward the pocket region.

FIG. 6 is a top view showing the towel in a compact stacked configuration with the interior side facing upward.

FIG. 7 is a view showing the folded towel with the pocket panel visible and the rearward pocket opening exposed.

FIG. 8 is a view showing the inversion step in which the towel is turned inside-out through the rearward pocket opening to form the trivet or pot-holder configuration.

FIGS. 9A and 9B are views showing the towel in its final converted configuration; FIG. 9A is a top-side perspective view of the inverted towel, and FIG. 9B is a top-plan view illustrating the compact, multi-layered form.

### DETAILED DESCRIPTION OF THE INVENTION

The following description sets forth exemplary aspects of the present disclosure. These examples are intended to illustrate the concepts of the invention and are not limiting in scope. Combinations, modifications, and variations that achieve equivalent results are also contemplated within the spirit of this disclosure.

The present disclosure relates to a convertible, multi-functional fabric towel capable of serving multiple purposes in domestic and outdoor environments. The towel may function as a drying towel, pot holder, trivet, or oven mitt depending on how it is folded or grasped. Additional applications may include use as a seat pad, heat-protective surface, or general household utility cloth. The towel is adaptable for drying, shielding, gripping, and heat protection without requiring multiple separate items.

In some aspects, the towel comprises a rectangular fabric body having opposed first and second surfaces and a continuous finished edge formed by stitching or hemming. A pocket portion is integrally attached as a discrete fabric panel along the outer back edge of the towel body. The pocket defines an opening oriented rearwardly (outwardly) and is sized to receive the user's hand for grasping or shielding. In certain embodiments, the pocket panel is constructed from two layers of fabric joined along their edges to form a dual-ply region that enhances heat protection. In other embodiments, the pocket panel is formed from a single layer of thick, heat-resistant fabric sufficient to achieve similar protective functionality. The towel is composed entirely of fabric and does not include magnets, metallic fasteners, drawstrings, loops, silicone, neoprene, quilting, or insulating batting materials.

The towel provides several functional advantages. The rearward orientation of the pocket allows the user's hand to remain shielded behind the towel during use, improving safety and control. The all-fabric construction maintains flexibility and washability while eliminating the bulk commonly found in oven mitts or padded holders. When unfolded, the towel serves as a conventional drying towel or countertop protector. When the user's hand is inserted into the pocket, the towel can be used to lift, carry, or stabilize heated or wet objects. When folded within itself, it functions as a trivet to protect surfaces from heat. The towel thereby provides a single, integrated textile solution adaptable to a range of everyday tasks.

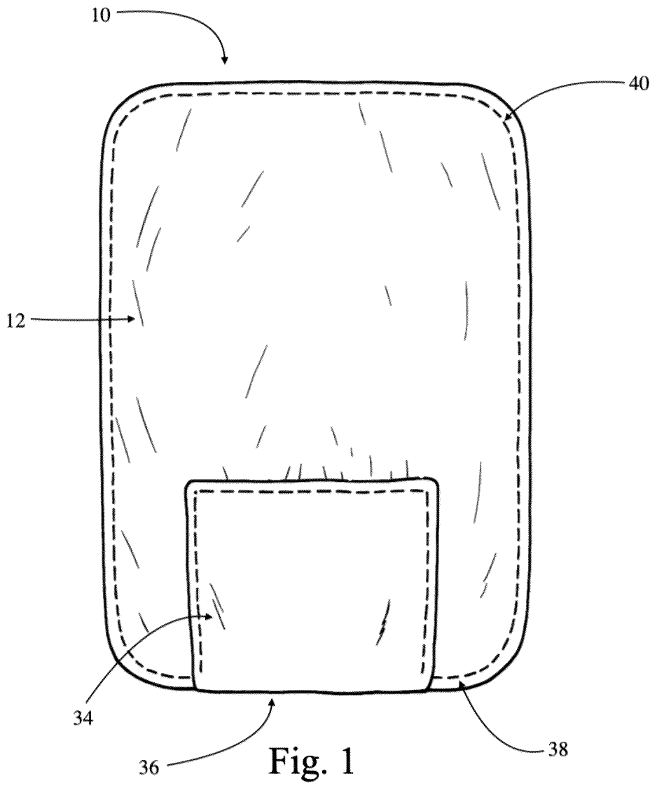

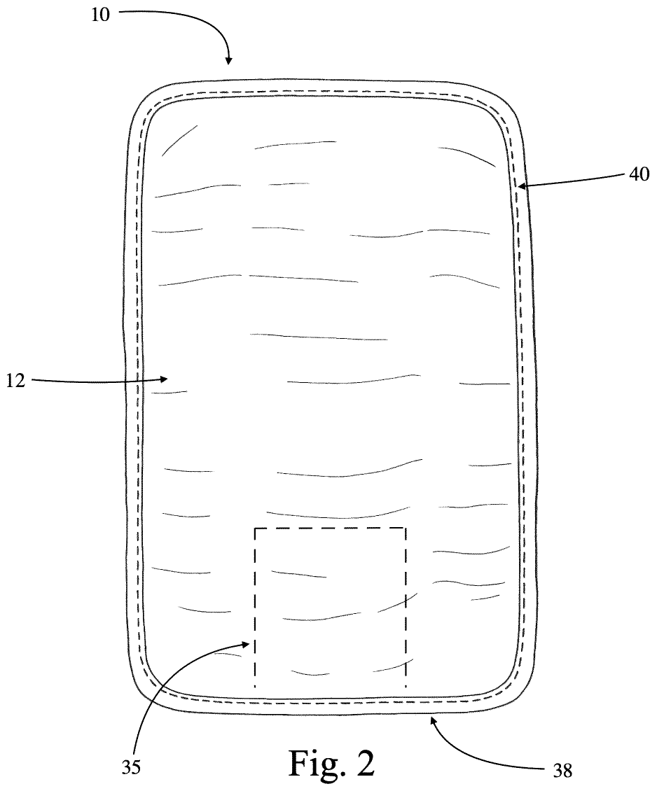

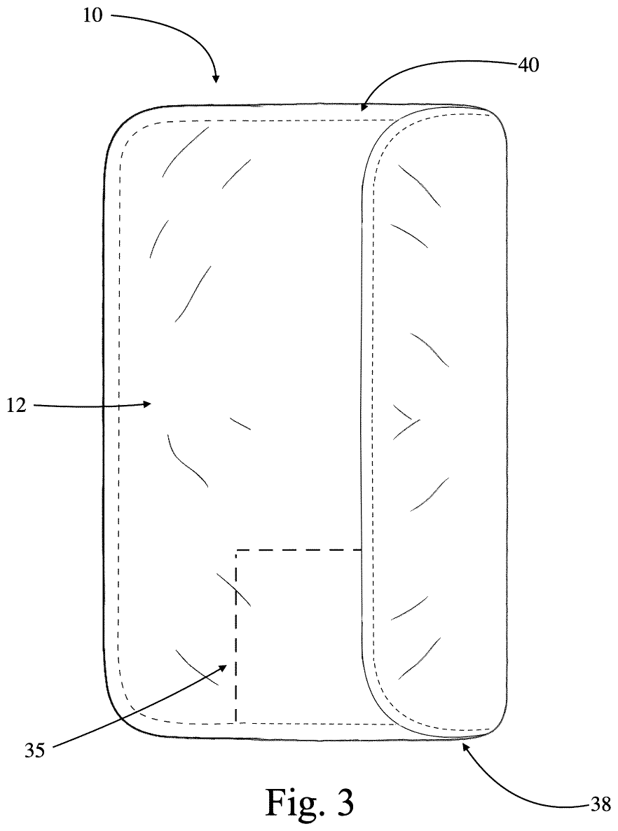

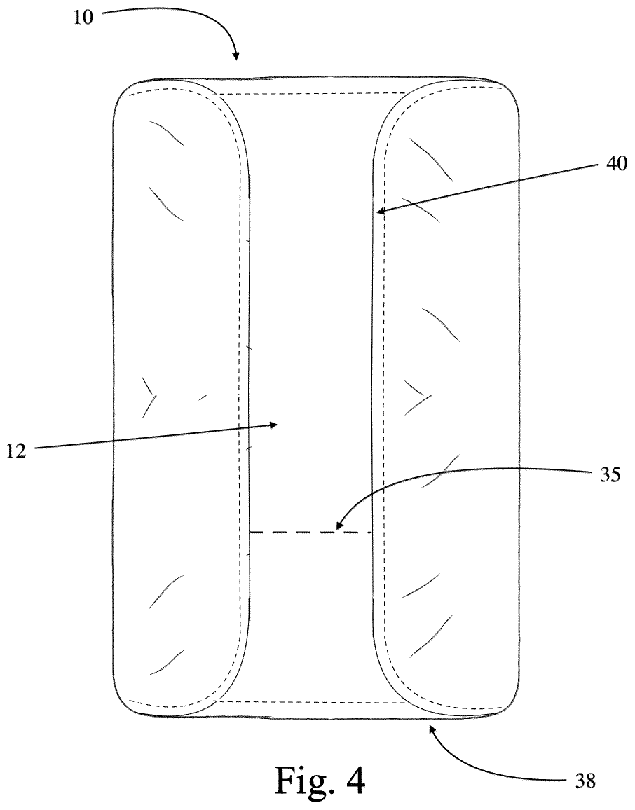

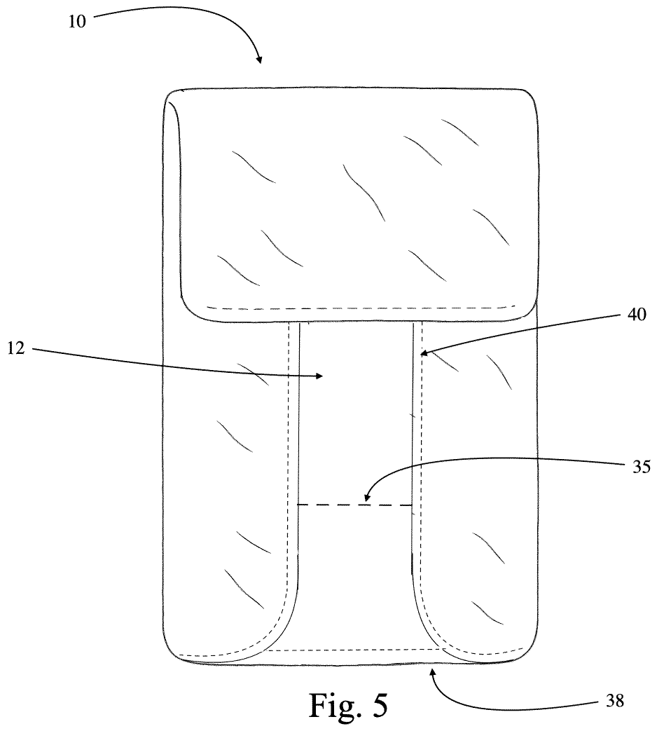

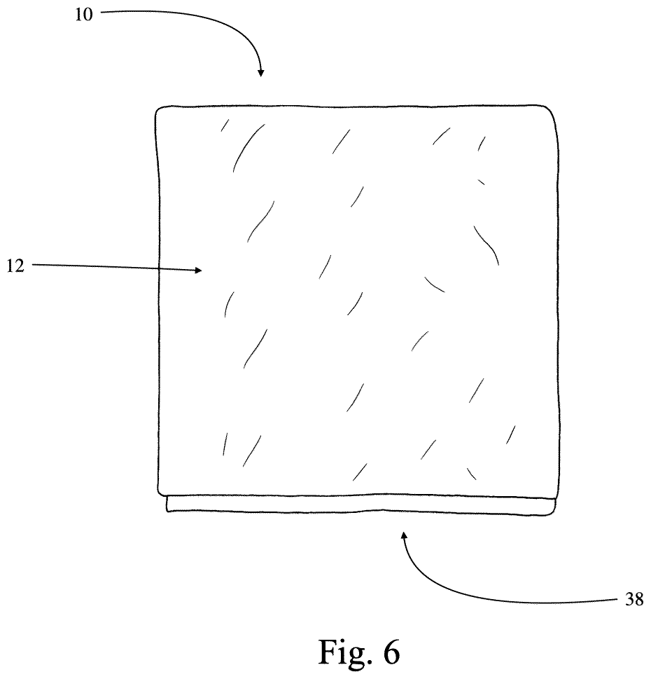

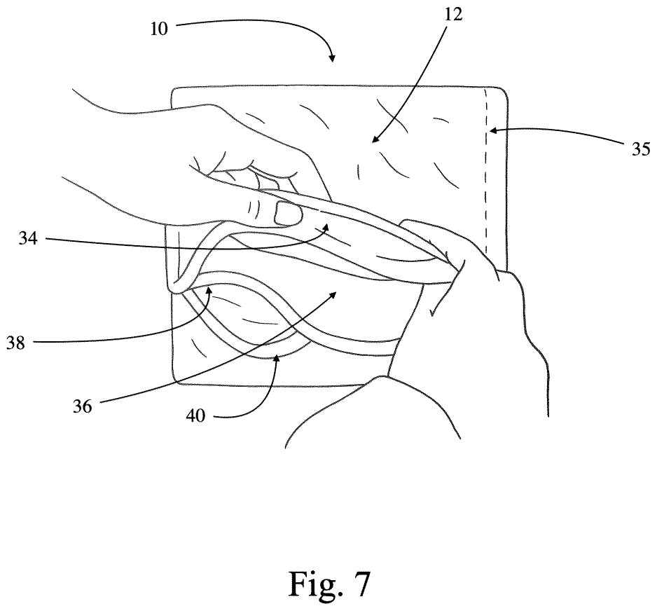

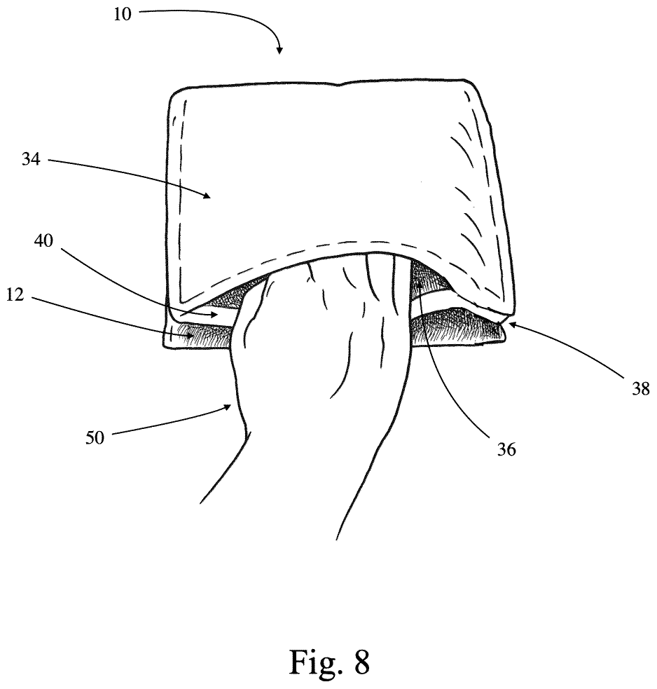

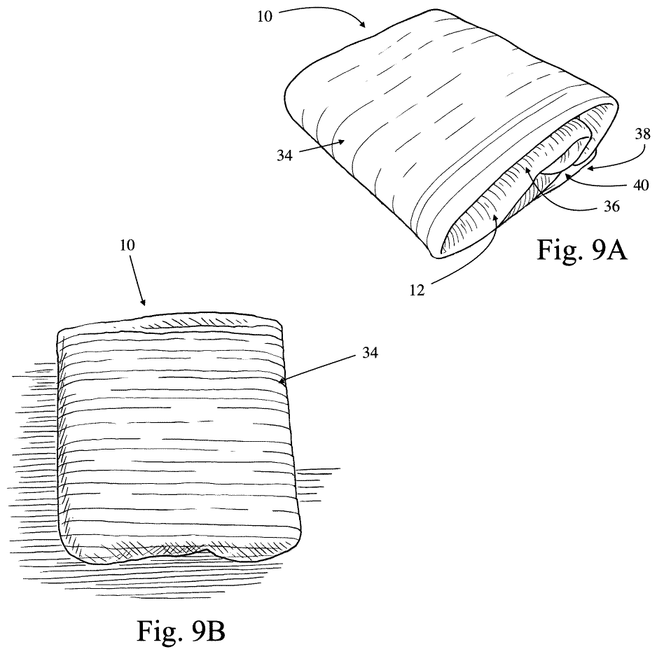

Referring to FIG. 1 shows the interior side of the towel body (12) laid flat with the pocket panel (34) visible and facing upward. The pocket panel (34) is attached along the outer back edge (38) and defines a rearwardly oriented opening (36) sized to receive a user's hand. The towel perimeter includes a continuous finished seam (40) surrounding the fabric edges. Referring to FIG. 2 illustrates the exterior side of the towel body (12) laid flat, showing the continuous finished seam (40) around the perimeter. The pocket panel (34) is not visible in this view; however, the stitching line (35) that secures the pocket panel to the towel body along the outer back edge (38) is visible, indicating the pocket's attachment position. Referring to FIG. 3 depicts the first folding step in which the right long edge of the towel body (12) is folded inward toward the center line along the seam near the pocket attachment. The towel remains viewed from the exterior side, with the stitching line (35) visible along the outer back edge (38) and the continuous finished seam (40) shown around the perimeter. Referring to FIG. 4 illustrates the second folding step, in which the left long edge of the towel body (12) is folded inward toward the center line, positioned adjacent to the previously folded right-hand portion without overlapping it. The towel remains viewed from the exterior side, showing the stitching line (35) that attaches the hidden pocket panel along the outer back edge (38). The continuous finished seam (40) is visible along the perimeter of the towel. Referring to FIG. 5 shows the upper edge of the towel body (12) being folded downward toward the pocket region located on the opposite side. The stitching line (35) remains visible along the outer back edge (38), and the continuous finished seam (40) outlines the towel perimeter. Referring to FIG. 6 illustrates a top view of the towel body (12) after completion of a second downward fold, forming a compact, stacked configuration. At this stage, the interior side of the towel (the side including the pocket panel 34) is now facing upward, while the exterior side is folded inward and concealed between the layers. The folds create a neatly layered rectangular section positioned above the pocket region. Because the exterior edges are now turned inward, the stitching line (35) and finished seam (40) are not visible in this view. This configuration represents the folded state immediately preceding exposure of the pocket opening shown in FIG. 7. Referring to FIG. 7 shows the towel body (12) in the folded state, viewed from the interior side (i.e., FIG. 6 flipped over). In this configuration, the pocket panel (34) is visible, and the rearward pocket opening (36) is exposed along the outer back edge (38). The continuous finished seam (40) may be visible along the upper edge. Referring to FIG. 8 illustrates the inversion step in which the user's hand (50) (not claimed) enters the rearward pocket opening (36) to grasp interior fabric of the towel body (12). Pulling upward and outward turns the pocket panel (34) and adjacent layers inside-out, drawing the folded towel through the opening (36). The outer back edge (38) and finished seam (40) are visible along the periphery during inversion. Referring to FIGS. 9A and 9B depict the towel (10) in its final converted configuration after inversion. The folded and inverted layers of the towel body (12) form a compact, multi-layered section that provides heat protection through fabric thickness alone. The pocket panel (34) now defines the outer contact surface suitable for resting hot cookware, with the rearward pocket opening (36) remaining accessible for use as a pot holder. The outer back edge (38) and finished seam (40) outline the boundary of this configuration. FIG. 9A presents a top-side perspective view showing elements 10, 12, 34, 36, 38, and 40, while FIG. 9B provides a top-plan view in which only the towel (10) and the outer surface of the inverted pocket panel (34) are visible.

A number of implementations have been described. Nevertheless, various modifications may be made without departing from the spirit and scope of the invention. For example, the towel fabric may comprise any absorbent or heat-resistant textile, including cotton, linen, French terry, or microfiber. The pocket is formed by attaching a discrete fabric panel to the towel body along its perimeter, leaving a rearwardly oriented opening for insertion of the user's hand. In some embodiments, optional decorative stitching, texture variations, or color-contrasting panels may be incorporated without altering the functional characteristics or performance of the towel. Accordingly, other embodiments and variations consistent with these teachings remain within the scope of the following claims.

### CONCLUSIONS, RAMIFICATIONS, AND SCOPE

The present disclosure introduces a convertible multi-purpose towel that unifies the practical functions of several traditional fabric-based utility items into a single article. The towel functions not only as a drying cloth but can also be reconfigured for use as a pot holder, oven mitt, or trivet, providing a versatile, space-efficient solution for a variety of household and outdoor applications.

The ramifications of this design are significant. By combining multiple fabric-based utilities into one article, the towel simplifies a user's experience, reduces the need for separate accessories, and minimizes storage requirements. The convertible nature of the towel allows it to transition between functional modes solely through its folding and inversion sequence without mechanical fasteners, magnets, or drawstrings resulting in a durable, washable, and environmentally friendly design.

The scope of the invention is not limited to the particular embodiments or configurations disclosed herein. Variations in size, geometry, and material composition may be adopted to accommodate different environments or user preferences. For example, the towel body and pocket panel may be constructed from any absorbent or heat-resistant textile such as cotton, linen, French terry, or microfiber, and may include decorative or antimicrobial finishes without departing from the inventive concept.

The utility of the towel extends beyond culinary applications. The same folding and inversion principles may be adapted for use in settings such as camping, automotive maintenance, or other activities where a compact, protective, and absorbent fabric article is advantageous. The embodiments described are therefore illustrative rather than restrictive, and the invention is to be accorded the broadest scope consistent with the claims and their equivalents.

REFERENCE NUMERAL KEY

| Reference | |
|---|---|
| No. | Description |
| 10 | Convertible multi-purpose towel (overall article) |
| 12 | Towel body (rectangular base sheet) |
| 34 | Pocket panel |
| 35 | Stitching securing pocket panel to towel body |
| 36 | Rearwardly oriented pocket opening |
| 38 | Outer back edge of towel body |
| 40 | Continuous finished seam around towel perimeter |
| 50 | User's hand (illustrated for functional context only) |

What is claimed is:

1. A multi-functional fabric towel, comprising:
a rectangular fabric body having opposed first and second surfaces and a continuous finished edge;
a pocket panel constructed from fabric and attached along its perimeter to an outer back edge of the towel body, the pocket panel defining a rearwardly oriented opening sized to receive a user's hand; and
wherein the towel is selectively usable as at least one of a towel, pot holder, trivet, or oven mitt;
wherein the towel and pocket panel are composed entirely of fabric and are free of magnets, metallic fasteners, drawstrings, loops, silicone, neoprene, PVC dots, quilting, and insulating batting materials.

2. The towel of claim 1, wherein the pocket panel comprises two layers of fabric joined along their edges to form a dual-ply region for enhanced heat protection.

3. The towel of claim 1, wherein the pocket panel comprises a single layer of thick, heat-resistant fabric sufficient to provide heat protection.

4. The towel of claim 1, wherein the rearwardly oriented opening is positioned substantially along a lower outer back edge of the towel body.

5. The towel of claim 1, wherein the towel body and pocket panel are formed from the same fabric material selected from the group consisting of cotton, linen, French terry, and microfiber.

6. The towel of claim 1, wherein the towel body and pocket panel are formed from different fabric materials selected to provide varied absorbency or heat resistance.

7. The towel of claim 1, wherein the pocket panel is attached to the towel body by stitched seams along its sides and base, leaving the rearwardly oriented opening unstitched.

8. The towel of claim 1, wherein the continuous finished edge is formed by a hemmed or overlocked seam extending around the entire towel body.

9. The towel of claim 1, wherein the towel further includes optional decorative stitching or contrasting thread color visible along the pocket seam or outer edges.

10. The towel of claim 1, wherein the towel is washable and reusable,
maintaining flexibility and absorbency after repeated laundering cycles.

11. The towel of claim 1, wherein the pocket panel is dimensioned to fully enclose the user's hand during use.

12. The towel of claim 1, wherein the towel is convertible into a trivet configuration by folding the towel body inward and inverting the pocket panel, such that the pocket portion is turned inside-out to form a flat, multi-layered section suitable for supporting heated cookware or other hot objects.

13. The towel of claim 1, wherein in the trivet configuration, the user may insert their hand into the pocket portion to grasp, lift, or reposition heated objects, thereby allowing the towel to function interchangeably as a pot holder or oven mitt.

14. The towel of claim 1, wherein the pocket panel and towel body collectively provide at least two layers of fabric in regions intended for gripping heated objects.

15. The towel of claim 1, wherein the towel body is foldable transversely over the pocket panel to provide temporary extended coverage for the user's forearm, such that when the user's hand is inserted into the pocket, the upper portion of the towel can be pulled toward the user to form an additional protective layer between the pocket and a heated object.

16. The towel of claim 1, wherein the pocket panel and towel body are secured by lockstitch, chainstitch, or overlock stitching suitable for repeated heat exposure and laundering.

17. The towel of claim 1, wherein the towel body is composed of absorbent woven or nonwoven textile fibers selected from natural or blended fabrics.

18. The towel of claim 1, wherein the towel maintains a uniform thickness and flexibility across the body and pocket regions, enabling it to conform to the shape of cookware or surfaces.

19. A convertible multi-functional towel, comprising:
a rectangular fabric body having opposed interior and exterior surfaces;
a pocket panel attached along its perimeter to an outer back edge of the towel body and defining a rearwardly oriented hand opening;
wherein the pocket panel comprises a single or dual-layer fabric construction providing heat protection through material thickness; and
wherein the towel is configured to be folded and inverted within itself to transform selectively between a towel, trivet, pot holder, or oven mitt configuration, each configuration formed solely through folding and inversion of the towel body and pocket panel without mechanical attachments or non-fabric inserts.

20. (canceled)
